(19) United States
(12) Patent Application Publication
(10) Pub. No.: US 2018/0013616 A1
(43) Pub. Date: Jan. 11, 2018

(54) METHOD FOR DYNAMIC CHANGE OF APPLICATION BEHAVIOR BY CONFIGURATION

(71) Applicant: International Business Machines Corporation, Armonk, NY (US)

(72) Inventors: Aharon Abadi, Petach Tikva (IL); Idan Ben-Harrush, Givat Elah (IL); Nili Ifergan-Guy, Haifa (IL); Dmitri Pikus, Haifa (IL); Oleg Sternberg, Haifa (IL)

(21) Appl. No.: 15/203,814

(22) Filed: Jul. 7, 2016

(51) Int. Cl. H04L 12/24; H04L 29/06

(52) U.S. Cl. CPC H04L 41/082; H04L 67/42

(57) ABSTRACT

This invention relates to an apparatus, system, and method for modifying the behavior of an application using configuration. A configuration platform allows for the provisioning of configuration data on a local device. The configuration can cause the application to be reactive to the user's environment, such as location and time of day. The configuration data provides a convenient way to change application behavior without implementing dynamic behavior at development time.

### FIELD OF TECHNOLOGY

The present invention is in the technical field of responsive applications. More particularly, the present invention is in the field of dynamic application behavior by configuration.

### BACKGROUND OF THE INVENTION

Applications are computer software designed to help a user perform one or more specific tasks. Applications may be downloaded to perform particular tasks for mobile electronic devices, such as smartphones, tablets, multimedia players, and gaming systems, or computing systems, such as personal computers and laptops.

Computers and computer applications are a critical tool for businesses and consumers. Users often install applications to tailor their computer for their particular needs. Such application installation is typically done at one point in time, and the application remains fixed in terms of its executable components. To better serve users, businesses have begun to customize applications. However, these customization decisions require knowledge ahead of time as to the particular use cases and environments that the user will experience.

Particularly for conventional mobile applications, the client software has a static design that may contain one or more layout, data model, and logistics. Changes to this static design must be made at development time.

As customer demands change and consumers expect more responsive designs in applications, the burden on the developer has increased. Typically, a developer might have to customize an application for each specific environment. Adapting an application to its environment might include changing the color of the price indicator during a deal period, offering premium customer special offers, defining content and layout in an application based on the employee's role, or defining the content and layout based on a banking customer's user identifier and account type. For enterprise applications in the defense market, it is necessary to prevent exposure of some secret modules to the client. These modules have to be loaded at runtime and executed in a secure container based on the configuration.

Currently, an application may receive application configuration parameters from a server or other backend service, such as the Parse tool from Facebook. However, this approach is unable to handle the above examples in an efficient, convenient manner. Other approaches, such as the Java Spring framework or aspect oriented programming, can be used to link application components dynamically. This approach also fails to provide an end-to-end solution for the above examples, and don't allow executing configuration during allowed periods of time. Furthermore, these approaches don't allow for the loading and execution of code in a secure container.

The dynamically exposed features in the application can be achieved by statically including the code fragment inside the application and enabling or disabling the feature. However this approach increases the application size. Increasing the application size has disadvantages, especially for Internet of Things (IOT) devices that have limited resources. Also, this approach requires that features are predefined.

What is needed is a method for dynamically changing an application's behavior by configuration.

### SUMMARY OF INVENTION

This summary is provided with the understanding that it will not be used to limit the scope or meaning of the claims.

The present invention relates to defining configurations for mobile applications. The configuration may contain expiration period, executable code, metadata with directives on how to run the loaded code and other parameters or data, that may control application behavior, such as remove or add application data or control. The present invention further relates to implementing an execution environment that is controlled by the configuration.

In embodiments, a system for modifying application behavior comprises a configuration server configured to receive a set of environment data, generate a configuration based on the set of environment data, and a client device comprising at least one application and configured to generate and transmit to the configuration server the set of environment data, receive from the configuration server the configuration and modify the execution of the at least one application. Such an embodiment provides advantages of modifying application behavior without modification to the application after its deployment, but can use configuration to change the application behavior.

In a permissive embodiment, the configuration comprises at least one parameter, and the application changes control flow based on the at least one parameter. In optional embodiments, the environment data comprises the client device location and/or the current time. In other optional embodiments, the format of the configuration is an Extensible Markup Language document or JavaScript Object Notation formatted data. In preferred embodiments, the configuration comprises a conditional statement and is configured to change control flow. In permissive embodiments, the application is defined to change dynamically or comprises a Spring Framework implementation, where the configuration dynamically controls a linkage between application parts.

In an optional embodiment, the configuration comprises an executable code. The configuration, in a permissive embodiment, comprises instructions to run the executable code inside of a container, such as a Docker container.

In an embodiment, a method for modifying application behavior comprises generating a set of environment data by a client device, where the client device comprises at least one application, transmitting the environment data by the client device to a configuration server; receiving the environment data by the configuration server, generating a configuration by the configuration server, where the configuration is based on the environment data, transmitting, by the configuration server, the configuration to the client device, receiving the configuration by the client device, and modifying the behavior of the at least one application based on the configuration. Such an embodiment is advantageous in allowing application behavior to be modified remotely without forcing the user to reinstall the application.

The methods and systems disclosed herein may be implemented in any means for achieving various aspects, and may be executed in a form of a machine-readable medium embodying a set of instructions that, when executed by a machine, cause the machine to perform any of the operations disclosed herein. These and other features, aspects and advantages of the present invention will become understood with reference to the following description, appended claims and accompanying figures.

### BRIEF DESCRIPTION OF THE DRAWINGS

Example embodiments are illustrated by way of example and not limitation in the figures of the accompanying drawings, in which like references indicate similar elements and in which:

FIG. 1A illustrates a user interface in a shopping application for a user in a cold climate, according to an embodiment of the present invention.

FIG. 1B illustrates a user interface in a shopping application for a user in a warm climate, according to an embodiment of the present invention.

FIG. 2A shows a user interface without a gradual search feature rollout enabled, according to an embodiment of the invention.

FIG. 2A shows a user interface with a gradual search feature rollout enabled, according to an embodiment of the invention.

FIG. 3 shows a flow diagram of a configuration modifying application behavior, according to an embodiment of the present invention.

FIG. 4 illustrates the communication between a configuration server and a client device, according to an embodiment of the present invention.

FIG. 5 shows a flow diagram of a configuration modifying application behavior, according to an embodiment of the present invention.

Other features of the present embodiments will be apparent from the Detailed Description that follows.

### DETAILED DESCRIPTION OF THE EMBODIMENTS

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention. Electrical, mechanical, logical and structural changes may be made to the embodiments without departing from the spirit and scope of the present teachings. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules. One of ordinary skill in the art would also readily recognize that the same principles are equally applicable to, and can be implemented in, different types of networked computer systems, and that any such variations do not depart from the true spirit and scope of the present teachings.

Generally, program modules include routines, programs, components, data structures, and other types of structures that perform particular tasks or implement particular abstract data types. Moreover, those skilled in the art will appreciate that embodiments may be practiced with other computer systems, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a non-transitory computer-readable memory device. The computer-readable storage medium can for example be implemented via one or more of a volatile computer memory, a non-volatile memory, a hard drive, a flash drive, and comparable media.

Throughout this specification, the term “platform” may be a combination of software and hardware components for employing an application configuration framework. Examples of platforms include, but are not limited to, a hosted service executed over a plurality of servers or an application executed on a single computing device. The term “server” generally refers to a computing device executing one or more software programs typically in a networked environment. However, a server may also be implemented as a virtual server executed on one or more computing devices viewed as a server on the network.

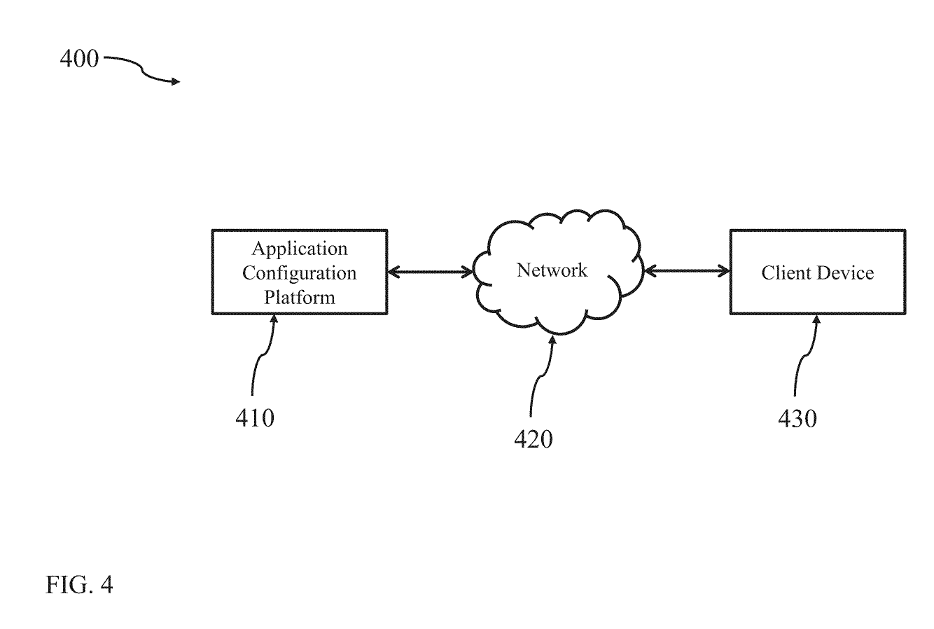

FIG. 4 illustrates the communication between an application configuration platform 410 and a client device 430, according to an embodiment of the present invention. Particularly, FIG. 4 illustrates the application behavior modifying system 400 that comprises a computing network 420, such as a WAN, a LAN, an application configuration platform 410, and a client device 430. The client device 430 may include a local processing device, and an application stored in a local memory of local processing device, according to one embodiment.

In an embodiment, the application configuration platform 410 may include several components communicating each other, such as a storage server and a processing server. The application configuration platform 410 and the client device may be communicatively coupled to the local system through a WAN. The client device 430 may include the local processing device. An application may be stored in a local memory of local processing device can contain a configuration file (or other configuration format) when such a configuration is received from the application configuration platform 410.

The components of the application configuration platform 410 may be communicatively coupled with the WAN. The application configuration platform 410 may be communicatively coupled with the client device 430 via the WAN. Network switches and/or routers enable communication between the different parts of the WAN. The WAN can use packet switching methods that implement an Internet Protocol network. The WAN may include the Internet.

According to one embodiment, the application configuration platform may include a network cloud. Data that is transmitted across a WAN enters the network from one end point through a standard protocol then enters the network cloud where it shares space with other data transmissions. The cloud computing network may include a collection of remote server and/or remote storage maintained by a third-party enterprise. The collection of remote server may include both primary and backup servers. The cloud computing network may include a specified number of clusters of remote storage and remote server. The clusters may be co-located with the network switches and/or routers. The network switches and/or routers may enable communication between the different parts of the cluster and a user of the cluster (e.g. the enterprise operating local system). For example, the cloud computing network may be an Amazon Elastic Compute Cloud™ (Amazon EC2) provided by Amazon Web Services™. The cloud computing network may provide real-time scalable resources that are provided on-demand. An application may be stored on a remote storage of the cloud computing network. The application may be installed on a remote server of the cloud computing network.

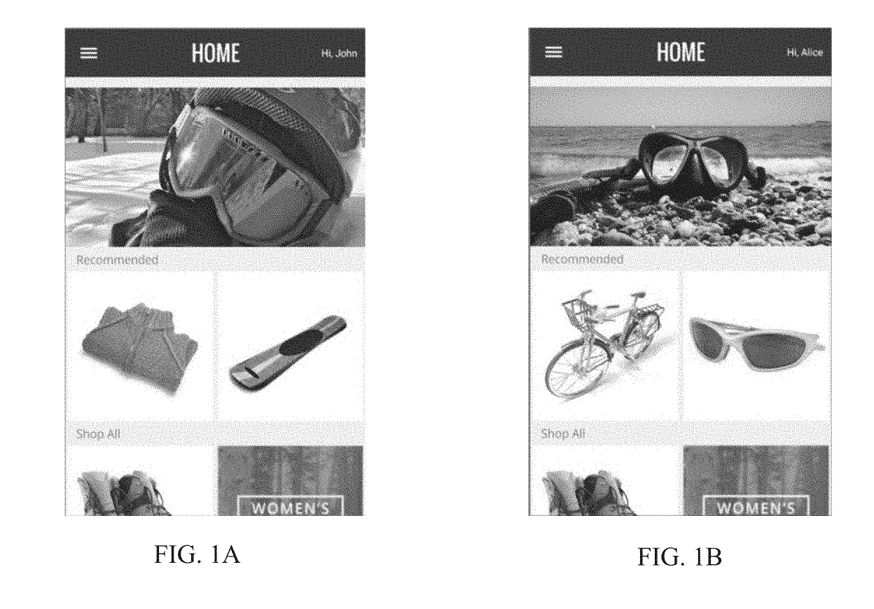

FIG. 1A illustrates a user interface in a shopping application for a user in a cold climate, according to an embodiment of the present invention, FIG. 1B illustrates a user interface in a shopping application for a user in a warm climate, according to an embodiment of the present invention. A client application executed on client device may display a user interface to access and interact with an application. This user interface and associated elements of the application uses configuration parameters to present different shopping items for sale according to the location of the user (i.e., the customer). In FIG. 1A, a user located in France will see winter sport items, whereas in FIG. 1B, a user located in Australia will see summer sport items.

A formal language can be used to describe the configurations. The language describes types and default values of configuration parameters, default values of parameters, and configuration expiration time. The language can also describe whether a parameter contains executable code, and how the application can execute this code. In an embodiment, the formal language is a regular expression. In other embodiments, the formal language is a JSON schema, XML schema, or other schema.

The configuration, once defined, is dynamically loaded into the application. The application execution is then changed according to configuration. This change can occur in several different ways, including, but not limited to: (1) changing control flow using conditional statements; (2) using techniques similar to aspect-oriented programming, significant parts of the application behavior could be defined to be changed dynamically; (3) using techniques similar to Spring Framework, linkage between application parts could be controlled dynamically; (4) allowing the application to load code dynamically and execute it for configuration parameters that contain executable code; executing code in a container, such as a Docker container, particularly for code that requires secured environment; and (5) supporting at the language level by a language that supports dynamic declaration of application blocks and linkage between modules.

Referring again to FIG. 1, the application in both FIG. 1A and in FIG. 1B execute the same code. The application dynamically fetches the configuration from a remote configuration service. However, the service will provide different configurations in each case, which in turn causes the application to react differently.

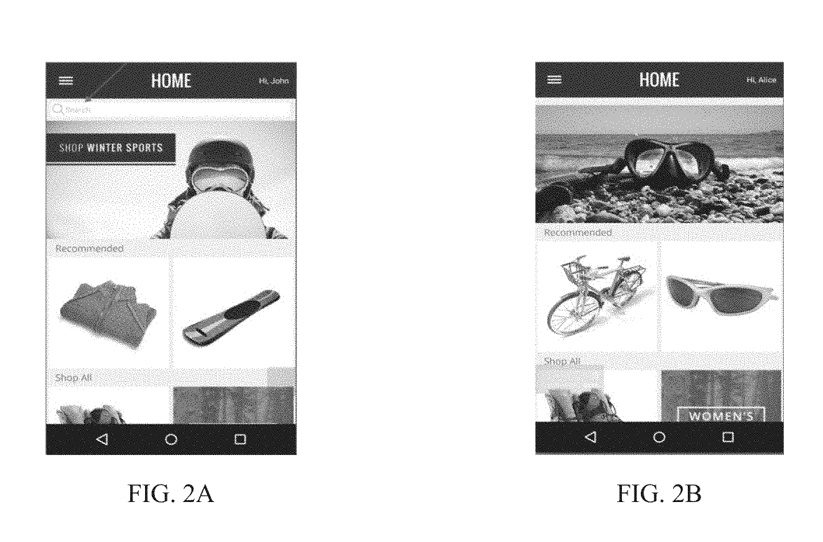

FIG. 2A shows a user interface without a gradual search feature rollout enabled, according to an embodiment of the invention, whereas FIG. 2B shows a user interface with a gradual search feature rollout enabled, according to an embodiment of the invention. In this case, an application developer plans to release a new feature, but wants to deploy the new feature only to a select group of users first. When the user is part of the select group, he or she will see the feature enabled. In FIG. 2A, the user interface displays a search field, whereas in FIG. 2B, the user is not presented with the search field. Thus, the developer is able to dynamically change the flow of application.

The configuration service can also be used to dynamically inject executable code into the application. The code that is injected can be based in the context, such as device type, operating system, location, or user behavior.

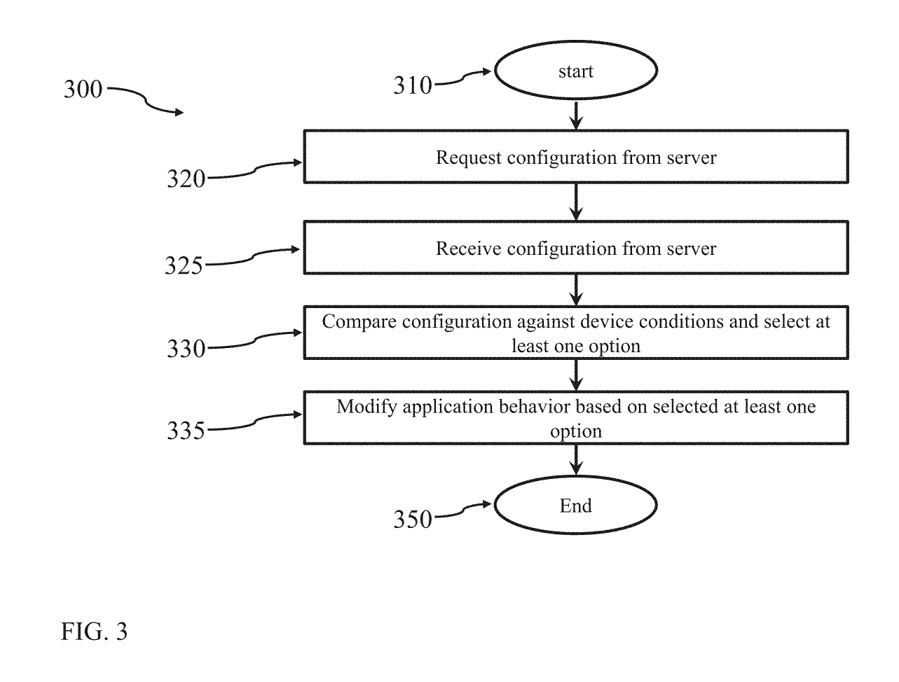

FIG. 3 shows a flow diagram 300 of a configuration modifying application behavior, according to an embodiment of the present invention. In this embodiment, the process starts at step 310. In step 320, the application on the client device will request a configuration from a server in the application configuration platform. The configuration, in an embodiment, is a file containing parameters or other type of data. In an alternative embodiment, the configuration is a data stream from the server in the application configuration platform. The server will provide the configuration to the application, which is received by the client device in step 325. In step 330, the application on the client device will contain an executable code portion that interprets the content of the configuration and will select at least one option based on the content of the configuration. In step 335, the selected at least one option will cause the application behavior to be modified, and the process ends in step 350.

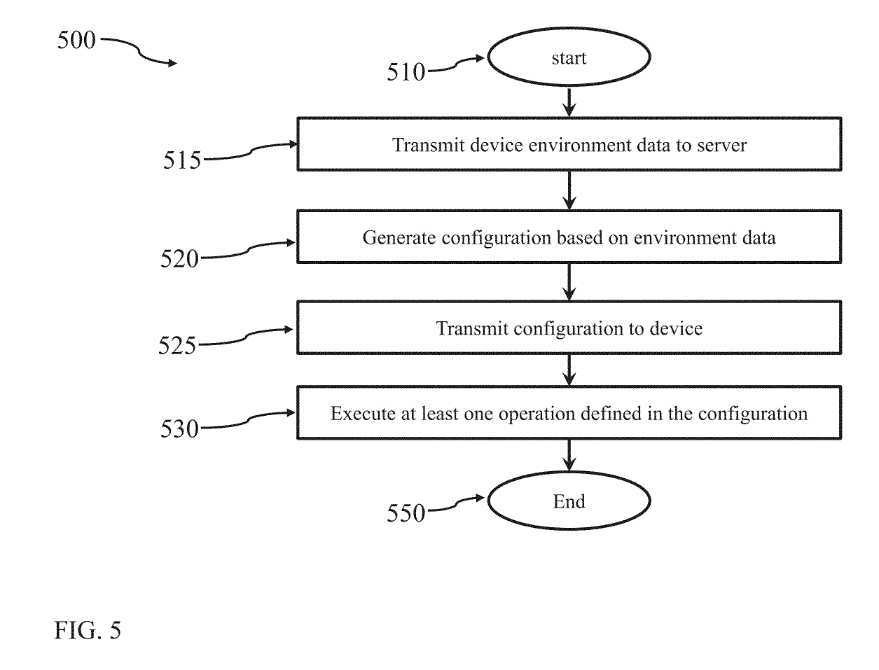

FIG. 5 shows a flow diagram 500 of a configuration modifying application behavior, according to an embodiment of the present invention. The configuration may be a file, although other data formats, such as data streams, are possible. In step 510, the process is started. In step 515, the client device will transmit at least one piece of environment data to a server in the application configuration platform. In step 520, the application configuration platform will generate a configuration, which it then transmits to the client device in step 525. In step 530, the application on the client device will execute at least one operation defined in the configuration, and in step 550, the processes ends.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. To the extent necessary to understand or complete the disclosure of the present invention, all publications, patents, and patent applications mentioned herein are expressly incorporated by reference therein to the same extent as though each were individually so incorporated.

Having thus described exemplary embodiments of the present invention, those skilled in the art will appreciate that the within disclosures are exemplary only and that various other alternatives, adaptations, and modifications may be made within the scope of the present invention. In addition, while a particular feature of the teachings may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.”

Other embodiments of the teachings will be apparent to those skilled in the art from consideration of the specification and practice of the teachings disclosed herein. It is intended that the specification and examples be considered as exemplary only. Accordingly, the present invention is not limited to the specific embodiments as illustrated herein, but is only limited by the following claims.

We claim:

1. A system for modifying application behavior comprising:
a. a configuration server configured to receive a set of environment data, generate a configuration data based on the set of environment data; and
b. a client device comprising at least one application and configured to generate and transmit to the configuration server the set of environment data, receive from the configuration server the configuration data and modify the execution of the at least one application.

2. The system of claim 1, wherein the configuration data comprises at least one parameter, and wherein the application changes control flow based on the at least one parameter.

3. The system of claim 1, wherein the environment data comprises the client device location.

4. The system of claim 1, wherein the environment data comprises the current time.

5. The system of claim 1, wherein the configuration data comprises an Extensible Markup Language document.

6. The system of claim 1, wherein the configuration data comprises JavaScript Object Notation formatted data.

7. The system of claim 1, wherein the configuration data comprises a conditional statement and is configured to change control flow.

8. The system of claim 1, wherein the at least one application is defined to change dynamically.

9. The system of claim 1, wherein the at least one application comprises a Spring Framework implementation, and wherein the configuration data dynamically controls a linkage between application parts.

10. The system of claim 1, wherein the configuration data comprises an executable code.

11. The system of claim 10, wherein the configuration data comprises instructions to run the executable code inside of a container.

12. The system of claim 11, wherein the container is a Docker container.

13. A method for modifying application behavior comprising:
a. generating a set of environment data by a client device, wherein the client device comprises at least one application;
b. transmitting the environment data by the client device to a configuration server;
c. receiving the environment data by the configuration server;
d. generating a configuration data by the configuration server, wherein the configuration is based on the environment data;
e. transmitting, by the configuration server, the configuration data to the client device;
f. receiving the configuration data by the client device; and
g. modifying the behavior of the at least one application based on the configuration data.

14. The method of claim 13, wherein the configuration data comprises at least one parameter, and wherein the application changes control flow based on the at least one parameter.

15. The method of claim 13, wherein the environment data comprises the client device location.

16. The method of claim 13, wherein the environment data comprises the current time.

17. The method of claim 13, wherein the configuration data comprises an Extensible Markup Language document.

18. The method of claim 13, wherein the configuration data comprises JavaScript Object Notation formatted data.

19. The method of claim 13, wherein the configuration data comprises an executable code.

20. A non-transient computer readable medium containing program instructions for causing a computer to perform the method of:
a. generate a set of environment data;
b. transmit the set of environment data to a server;
c. receive a configuration data from the server, wherein the configuration data is based on the environment data; and
d. modify the behavior of the at least one application based on the configuration data.
